(19) United States
(12) Patent Application Publication
(10) Pub. No.: US 2023/0161029 A1
(43) Pub. Date: May 25, 2023

(54) System and Method for Object Detection in a Hyperloop System

(71) Applicant: Hyperloop Technologies, Inc., Los Angeles, CA (US)

(72) Inventors: Aaron Glen Giddens, Huntington Beach, CA (US); Patrick Yousefian, Los Angeles, CA (US); Peter Gloria, Los Angeles, CA (US)

(73) Assignees: Hyperloop Technologies, Inc., Los Angeles, CA (US); Hyperloop Technologies, Inc., Los Angeles, CA (US)

(21) Appl. No.: 17/947,115

(22) Filed: Sep. 17, 2022

Related U.S. Application Data
(60) Provisional application No. 63/271,026, filed on Oct. 22, 2021.

(51) Int. Cl. G01S 13/86; G01S 13/931; G01S 17/931

(52) U.S. Cl. CPC G01S 13/865; G01S 13/867; G01S 13/931; G01S 17/931

(57) ABSTRACT

The disclosed solution generally relates to a hyperloop vehicle detecting objects in a hyperloop system. Hyperloop vehicles operate at incredible velocities and require robust systems to detect objects that increase the risk to a hyperloop vehicle. Transponders typically provide long-range data about the activity of downstream hyperloop vehicles. However, nearby objects require detection at line-of-sight distances in order to ensure that objects and vehicles within a given transponder interval distance are detected. The disclosed system provides an elegant solution that combines the advantages of both transponder-based object detection and sensor-based object detection.

### CROSS REFERENCE AND PRIORITY TO RELATED APPLICATIONS

This application claims the benefit of priority to: U.S. Provisional No. 63/271,026 entitled “SYSTEM AND METHOD FOR OBJECT DETECTION IN A HYPERLOOP SYSTEM,” filed on Oct. 22, 2021.

All the aforementioned applications are hereby incorporated by reference in their entirety.

### BACKGROUND

Hyperloop is a new mode of transportation relying on a hyperloop vehicle traveling through a tube having a near-vacuum environment. The projected velocity of the hyperloop vehicle may exceed 700 mph (1,127 km/h) in commercialized implementations. A hyperloop vehicle may rely on many types of tracks for guidance. However, magnetic levitation (“maglev”) is generally favored over traditional wheeled implementations because maglev provides a substantially frictionless means of guidance, levitation, and propulsion. Having maglev coupled with near-vacuum environments provides for high, sustainable velocities of hyperloop vehicles moving through the tube. Thus, passengers and cargo can be transported with reduced carbon impact.

One area of concern is collision avoidance. With such high velocities, traditional solutions to determining braking distance are inadequate for applications in hyperloop. For example, traditional rail still relies on human operators as a fallback to engage braking systems. With hyperloop, however, such human operation is virtually impossible given the high speeds that would exceed any conceivable human reaction time. As such, processes are embedded in autonomous systems are largely responsible for braking and control.

Any reliable autonomous vehicle system requires input regarding downstream hyperloop vehicles (and other objects). An autonomous system typically accepts sensor input and causes a device to perform certain actions. Hyperloop is in a mature research and development phase where applying existing rail solutions to hyperloop simply cannot meet requirements. Without adequate sensor selection and sensor calibration, a risk of collision with objects is high, thus risking damage to the hyperloop vehicle (and the passengers and/or cargo therein).

Collisions aside, sensor input may be necessary for standard operation of a hyperloop vehicle. For example, two hyperloop vehicles may form a convoy wherein the a first hyperloop vehicle leads a second hyperloop vehicle. Convoying is a particularly difficult problem because of the challenges of detecting an object and/or vehicle without the assistance of transponders.

In sum, detection of objects is a critical component of autonomous operation of a hyperloop vehicle. What is needed is a system and method for object detection, in a hyperloop system, that employs various sensors configured to observe a line-of-sight area.

### SUMMARY

A solution is disclosed for a safety system and associated processes. The solution comprises a method for determining, at a processor, a safety margin of a first hyperloop vehicle, wherein the safety margin is associated with a braking distance of the first hyperloop vehicle, wherein the first hyperloop vehicle is upstream from a second hyperloop vehicle. The processor further receives, at the processor, sensor data within a line-of-sight distance. The processor further receives, at the processor, transponder data from a first transponder. The processor further determines, at the processor, a collision margin and further determines, at the processor and based on the sensor data and the transponder data, whether the second hyperloop vehicle is positioned outside the collision margin.

The processor further operates, at the processor and if the second hyperloop vehicle is positioned outside the collision margin, the first hyperloop vehicle in a normal mode, wherein the normal mode is associated with a first velocity, the first velocity being reached via use of a primary traction system. The processor further operates, at the processor and if the second hyperloop vehicle is within the collision margin, the first hyperloop vehicle in a caution mode, wherein the caution mode causes the first hyperloop vehicle to operate at a second velocity.

The second velocity is reached by using a primary traction system, wherein the second velocity is lower than the first velocity. The processor is further configured to detect, at the processor, the second hyperloop vehicle within a safety margin and further cause, at the processor, the first hyperloop vehicle to engage a secondary braking system to apply a first braking force to the first hyperloop vehicle. The sensor data comprises LiDAR sensor data, camera sensor data, radar sensor data, laser sensor data, or a combination thereof.

The sensor data indicates a presence of smoke via use of the LiDAR sensor data, the camera sensor data, or a combination thereof. The sensor data indicates a presence of fire via use of the radar sensor data, the camera sensor data, or a combination thereof. The sensor data is camera sensor data, wherein the camera sensor data is processed using computer vision to detect the second hyperloop vehicle. The processor further causes, at the processor, the first hyperloop vehicle to convoy behind the second hyperloop vehicle.

A safety system is disclosed for a first hyperloop vehicle, wherein the safety system comprises a memory and a processor. The processor is configured to determine, at a processor, a safety margin of a first hyperloop vehicle, wherein the safety margin is associated with a braking distance of the first hyperloop vehicle, wherein the first hyperloop vehicle is upstream from a second hyperloop vehicle. The processor further receives, at the processor, sensor data within a line-of-sight distance. The processor further receives, at the processor, transponder data from a first transponder. The processor further determines, at the processor, a collision margin and further determines, at the processor and based on the sensor data and the transponder data, whether the second hyperloop vehicle is positioned outside the collision margin.

The processor further operates, at the processor and if the second hyperloop vehicle is positioned outside the collision margin, the first hyperloop vehicle in a normal mode, wherein the normal mode is associated with a first velocity, the first velocity being reached via use of a primary traction system. The processor further operates, at the processor and if the second hyperloop vehicle is within the collision margin, the first hyperloop vehicle in a caution mode, wherein the caution mode causes the first hyperloop vehicle to operate at a second velocity.

The second velocity is reached by using a primary traction system, wherein the second velocity is lower than the first velocity. The processor is further configured to detect, at the processor, the second hyperloop vehicle within a safety margin and further cause, at the processor, the first hyperloop vehicle to engage a secondary braking system to apply a first braking force to the first hyperloop vehicle. The sensor data comprises LiDAR sensor data, camera sensor data, radar sensor data, laser sensor data, or a combination thereof.

The sensor data indicates a presence of smoke via use of the LiDAR sensor data, the camera sensor data, or a combination thereof. The sensor data indicates a presence of fire via use of the radar sensor data, the camera sensor data, or a combination thereof. The sensor data is camera sensor data, wherein the camera sensor data is processed using computer vision to detect the second hyperloop vehicle. The processor further causes, at the processor, the first hyperloop vehicle to convoy behind the second hyperloop vehicle.

### BRIEF DESCRIPTION OF DRAWINGS

The accompanying drawings, which are incorporated herein and constitute part of this specification, illustrate exemplary aspects of the claims, and together with the general description given above and the detailed description given below, serve to explain the features of the claims.

FIG. 1 illustrates a block diagram of a track assembly with a hyperloop vehicle.

FIG. 2 is a block diagram illustrating a hyperloop vehicle, shown from a side perspective.

FIG. 3A is a block diagram of a hyperloop vehicle positioned on a track assembly, as shown from a side perspective.

FIG. 3B is a block diagram of a hyperloop vehicle positioned on a track assembly, as shown from a front perspective.

FIG. 4A is a block diagram illustrating an automatic pod protection system.

FIG. 4B is a block diagram of a line-of-sight system.

FIG. 5A is a flowchart depicting a process for operating a hyperloop vehicle.

FIG. 5B is a flowchart depicting a process for operating a hyperloop vehicle.

FIG. 5C is a flowchart depicting a process for operating a hyperloop vehicle.

FIG. 6A is a block diagram illustrating a track assembly, shown from a side perspective.

FIG. 6B is a block diagram illustrating a track assembly, shown from a side perspective.

FIG. 6C is a block diagram illustrating a track assembly, shown from a side perspective.

FIG. 7 is a block diagram illustrating an example computing device suitable for use with the various aspects described herein.

FIG. 8 is a block diagram illustrating an example server suitable for use with the various aspects described herein.

### DETAILED DESCRIPTION

Various aspects will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

A hyperloop vehicle is a new mode of transportation that relies on maglev and a near-vacuum environment within a tube structure. Similar to traditional rail, hyperloop has a convoying system whereby a first hyperloop vehicle may be downstream from a second hyperloop vehicle, ad infinitum. Unlike traditional rail however, hyperloop operates at incredible velocities when compared to traditional rail viz. an order of magnitude higher. Therefore, collision avoidance is paramount to the successful commercialization of hyperloop.

Collision avoidance systems require information related to the locations of the objects and vehicles within the hyperloop system. Such information is derived from a number of sources. One source is a wayside transponder network which provides real-time information to hyperloop vehicles traveling through sections of tubes. Another source is a line-of-sight detection system which, as the name suggests, obtains measurements of objects within a line-of-sight. Line-of-sight includes in front of, laterally, and/or behind the hyperloop vehicle. One of skill in the art will appreciate that each of the aforementioned sources may be used independently or in conjunction, as defined by a particular implementation.

A wayside transponder (or simply a transponder) is a device affixed at or near the hyperloop track such that passing hyperloop vehicles may be detected and communicated with. A transponder may be integrated into a tube section that forms part of the hyperloop track. A passing hyperloop vehicle may trigger detection by the transponder in a number of manners. For example, the transponder may detect a passing hyperloop vehicle by use of a Hall effect sensor which activates when the ferromagnetic fuselage and/or bogie of the hyperloop vehicle passes by the transponder. Other implementations of transponders may include use of a laser sensor, an ultrasonic sensor, a mechanical sensor, etc. In any configuration, the wayside transponder is generally tasked with detection of the hyperloop vehicles and communication of critical information.

Transponders are relatively low-power devices that have limited capability to transmit large amounts of data. In general, a high-speed communication network is utilized for larger amounts of data (e.g., fleet management control signals, entertainment for passengers, etc.). However, the transponders have a critical role in providing relevant, recent information about nearby hyperloop vehicles, particularly those downstream. Given the high-velocity nature of hyperloop travel, line-of-sight detection of downstream vehicles is a risky approach. For instance, a downstream hyperloop vehicle may be stopped. If the line-of-sight is less than an operating braking distance, a collision might result unless a solution exists to notify the upstream vehicle of the downstream vehicle.

Line-of-sight systems are highly useful and not to the exclusion of any transponder-based solution for detection of objects, including hyperloop vehicles. In the event that the transponder network encounters a fault, the hyperloop vehicle may fallback to line-of-sight detection. However, fallback to line-of-sight detection naturally implies a fallback to lower velocities (i.e., a “caution mode” or commonly “limp mode”) in order to maintain a braking distance that is less than the line-of-sight distance (plus any desired margin).

With high-speeds, a hyperloop vehicle may require more information to reliably, safely, and efficiently operate than that of a traditional rail vehicle. As stated, traditional rail may rely on human operators and line-of-sight detection (whether by machine or by human operator); hyperloop cannot rely on those same means to the same extent. Unless new approaches to line-of-sight-based detection of objects is developed, the high speeds of hyperloop may result in dangerous conditions for passengers and/or cargo.

Transponders are typically placed at intervals along a track to provide information to hyperloop vehicles passing by the transponder. The transponder serves an important function of providing information about downstream hyperloop vehicles since those vehicles have passed the transponder already. However, hyperloop vehicles often operate within a transponder interval, i.e., between two transponders. As such, the upstream hyperloop vehicle will rely more on line-of-sight detection systems over other systems (including a transponder-based system).

Various line-of-sight detection systems have various strengths and weaknesses. Further, a single sensor may not address the use-cases and operating conditions of a hyperloop vehicle. For instance, the near-vacuum environment of the tube may impose limitations on the types and configurations of sensors. As another example, high velocity may affect certain types and configurations of sensors. Therefore, engineers and designers are seeking solutions to address line-of-sight detection challenges facing hyperloop.

A solution to the above-stated problems is a system and method for object detection, in a hyperloop system, that uses various sensors configured to observe a line-of-sight area. The disclosed solution improves reliability, safety, and efficiency of hyperloop transportation, thus enabling the growth of a green mode of transportation.

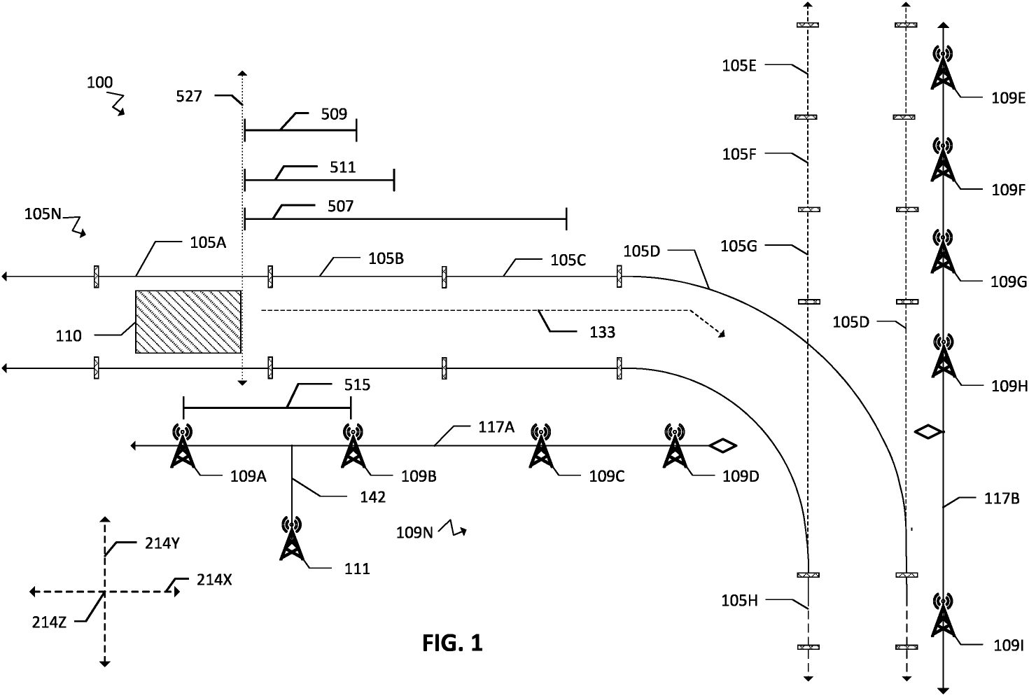

FIG. 1 illustrates a block diagram of a track assembly 100 with a hyperloop vehicle 110. A plurality of axes is shown to orient the reader viz. a first axis 214X, a second axis 214Y, and a third axis 214Z.

A plurality of tube sections 105N has a first tube section 105A, a second tube section 105B, a third tube section 105C, a fourth tube section 105D, a fifth tube section 105E, a sixth tube section 105F, a seventh tube section 105G, an eighth tube section 105H, and a ninth tube section 105I. The plurality of tube sections 105N are generally assembled together on the site of the track assembly 100. In one aspect, the plurality of tube sections 105N may be supported by pylons or other superstructures that elevate the tube above ground level. Such support structures are commonly referred to as “hyperstructure.” In another aspect, the plurality of tube sections 105N may have a near-vacuum environment such that the hyperloop vehicle 110 may operate with reduced air resistance. However, low air resistance enables high velocities that increase risk to passengers and/or cargo, hence the need for the disclosed solution.

The plurality of tube sections 105N has a track (not shown) disposed therein. In one aspect, the track may be made of laminated steel that is configured to enable maglev locomotion of the hyperloop vehicle 110. Other ferromagnetic materials may be similarly utilized.

A bogie assembly of the hyperloop vehicle 110 possesses the necessary systems to provide locomotion that is safe, energy efficient, and reliable. For instance, the bogie assembly may have propulsion systems that generate force by use of electromagnetic engines disposed near the rails of the track. The bogie assembly may have additional systems including braking systems, levitation systems, guidance systems, lighting systems, sensor systems, fault tolerance systems, passenger management systems, cargo management systems, navigation systems, communication systems, emergency systems, maintenance systems, etc.

The hyperloop vehicle comprises a pod assembly, that is configured to provide transportation of cargo, passengers, or a combination thereof. The pod assembly may have some of the systems of the bogie assembly (and vice versa). For the purposes of this disclosure, the hyperloop vehicle 110 will be generally referred to for both the bogie assembly and the pod assembly. One of skill in the art will appreciate that the internal configuration of the hyperloop vehicle 110 may vary depending on the operating environment of the hyperloop implementation.

A direction of travel 133 is shown to indicate the direction along which the hyperloop vehicle 110 is traveling. As shown, the hyperloop vehicle 110 is traveling along the axis 214X toward the tube section 105D at which point the hyperloop vehicle 110 will turn toward the section 105H. Thus, the direction of travel 133 transitions to become substantially parallel with the axis 214Y. The hyperloop vehicle 110 is configured to turn at high speeds; if a second hyperloop vehicle is traveling through the tube sections 105E, 105F, 105G, the hyperloop vehicle 110 may need to have such information in order to avoid a collision with the second hyperloop vehicle.

A plurality of transponders 109N are disposed at or near the plurality of tube sections 105N. The plurality of transponders 109N comprises a first transponder 109A, a second transponder 109B, a third transponder 109C, a fourth transponder 109D, a fifth transponder 109E, a sixth transponder 109F, a seventh transponder 109G, an eighth transponder 109H, and a ninth transponder 109I. The transponders 109A, 109B, 109C, 109D are interconnected by a link 117A. The transponders 109E, 109F, 109G, 109H, 109I are connected via a link 117B. In one aspect, the links 117A, 117B may be connected such that the plurality of transponders 109N is interconnected and understood be one network (or subnetwork). For clarity, a diamond symbol is shown to depict that the links 117A, 117B are interconnected.

A transponder is generally configured to communicate with the hyperloop vehicle 110 when in proximity to the transponder. Information may be sent from the transponder to the hyperloop vehicle 110 or vice versa, depending on operating conditions and parameters. For instance, the hyperloop vehicle 110 is shown as passing the transponder 109A in the instant view. The hyperloop vehicle 110 will pass the transponder 109B when traveling through the tube section 105B. In one aspect, the plurality of transponders 109N may correspond to each of the plurality of tube sections 105N. For instance, the tube section 105A corresponds to the transponder 109A. In one aspect, the tube section 105A may have the transponder 109A attached thereto and deployed as part of the tube section 105A.

A high-speed communication network 111 is available at or near the track assembly 100 such that the elements within the track assembly 100 may communicate with other elements in the track assembly 100. The high-speed communication network 111 is connected to the plurality of transponders 109N via a link 142. In one aspect, the plurality of transponders 109N may provide access to information communicated by the high-speed communication network 111. The high-speed communication network 111 may be a combination of wired and wireless communication means, in one aspect. In one aspect, the high-speed communication network 111 may be 5G. In another aspect, the high-speed communication network 111 may be WIFI. In general, the hyperloop vehicle 110 may be in communication with the high-speed communication network 111 as well as the plurality of transponders 109N, wherein each communication means has an assigned role. For instance, the plurality of transponders 109N may be charged with delivering short, critical messages whereas the high-speed communication network 111 may be charged with delivering long, less-critical messages.

The hyperloop vehicle 110 may communicate with a fleet management center (not shown) via the high-speed communication network 111 in order to communicate fleet-management data. For example, a message may be sent to the hyperloop vehicle 110 to instruct the hyperloop vehicle 110 to enter a stable for service. Such messages provide yet another source of data for the disclosed solution to enable guidance control of the hyperloop vehicle 110. For instance, the hyperloop vehicle 110 may require messages to guide the hyperloop vehicle through a non-moving switch (e.g., at or near the tube section 105D).

An axis 527 is positioned near the nose of the hyperloop vehicle 110 and is substantially parallel with the axis 214Y. A collision margin 507 begins at the axis 527 and proceeds along substantially parallel to the axis 214X. The collision margin 507 indicates a distance that the hyperloop vehicle 110 maintains in order to avoid a collision with a downstream object and/or hyperloop vehicle (e.g., a hyperloop vehicle positioned further along the direction of travel 133). One of skill in the art will appreciate that the collision margin 507 may be substantially related to the braking distance of the hyperloop vehicle 110. However, as the name suggests, the collision margin 507 is a margin which the hyperloop vehicle 110 maintains beyond the current braking distance of the hyperloop vehicle 110. Stated differently, a braking distance may be fifty meters, and the corresponding collision margin may be one hundred meters.

A line-of-sight distance 511 begins at the axis 527 and proceeds along the axis 214X. The line-of-sight distance 511 generally relates to the distance at which the hyperloop vehicle 110 detects objects based on sensors projected at a particular direction. In the instant figure, the direction is downstream, along the direction of travel 133.

One of skill in the art will appreciate that line-of-sight may imply different meanings depending on the circumstances. For example, line-of-sight may refer to detection of visual light as reflecting off solid bodies. Likewise, line-of-sight may refer to detection using ultrasonic sensors that rely on sound that can be observed in a line-of-sight between the hyperloop vehicle 110 and the sensors onboard. Still further, radar may be utilized to detect objects in front of the hyperloop vehicle 110 even though such objects may not be visible in the visual-light spectrum. For example, radar is particularly useful to detect objects obscured by gases and particles (e.g., smoke).

One of skill in the art will appreciate that line-of-sight may be projected in any direction, even though the line-of-sight distance 511 is projected along the direction of travel 133; for example, the line-of-sight may be projected from the tail of the hyperloop vehicle 110 or from the lateral sides of the hyperloop vehicle 110.

A safety margin 509 begins at the axis 527 and proceeds substantially parallel along the axis 214X. The safety margin 509 generally provides a distance at which the hyperloop vehicle 110 may engage a caution mode that causes the hyperloop vehicle 110 to slow considerably. One of skill in the art will appreciate that the line-of-sight distance 511 is longer than the safety margin 509. Therefore, if the onboard sensors of the hyperloop vehicle 110 detect an object within the line-of-sight distance 511, the safety margin 509 may be triggered, thus causing the hyperloop vehicle 110 to engage safety systems that result in reduced velocity (or entering a caution mode).

A transponder interval distance 515 is shown to indicate the distance between the transponders 109A, 109B. The transponder interval distance 515 may be the same as every other transponder interval distance (unlabeled in the instant view). However, one of skill in the art will appreciate that the interval distance between two transponders may vary at various points in the track assembly 100.

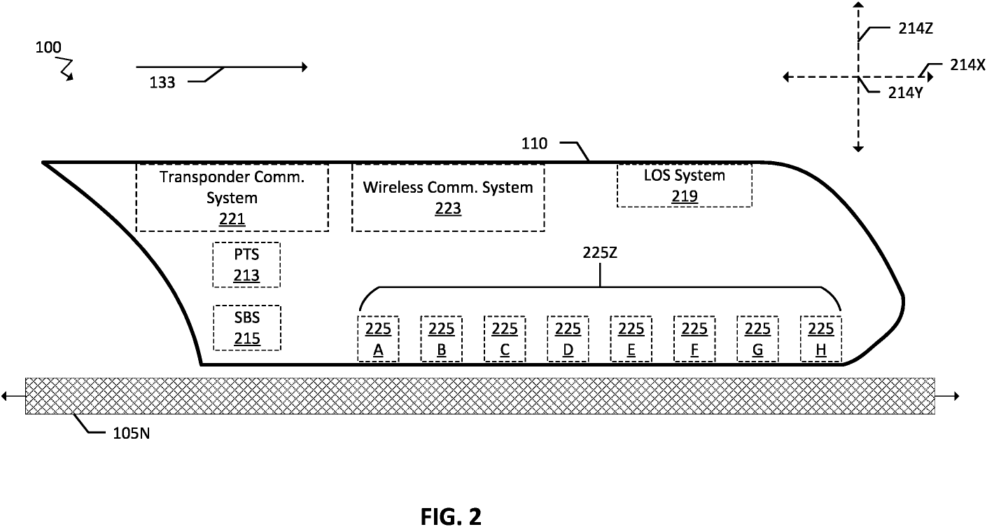

FIG. 2 is a block diagram illustrating the hyperloop vehicle 110, shown from a side perspective. The hyperloop vehicle 110 may have a number of systems, modules, subsystems, components, etc. Therefore, the terms system, module, subsystem, component, etc. may be utilized interchangeably throughout this disclosure, as understood by one of skill in the art. Any one of the named terms may be comprised of software, hardware, or a combination thereof.

The hyperloop vehicle 110 is positioned within the plurality of tube sections 105N. The plurality of tube sections 105N are shifted below the hyperloop vehicle 110 in order to more clearly show the disclosed solution. As stated in FIG. 1 above, the plurality of tube sections 105N comprise a track disposed therein.

The hyperloop vehicle 110 comprises a transponder communication system 221. The transponder communication system 221 is configured to communicate with the plurality of wayside transponders 109N that provides real-time information to the hyperloop vehicle 110 when the hyperloop vehicle 110 is in proximity to a transponder (e.g., the transponder 109A). For instance, the transponder 109A may provide transponder data.

Transponder data encompasses data relevant to upstream hyperloop vehicles about downstream hyperloop vehicles (and activities). Therefore, transponder data includes data related to a downstream hyperloop vehicle such as the downstream hyperloop vehicle velocity, the downstream hyperloop vehicle status (e.g., nominal, compromised, etc.), the wall clock time, or a combination thereof. Such transponder data may be utilized by the hyperloop vehicle 110 for braking operations. In short, the transponder data is configured such that the upstream hyperloop vehicle can, with some reliability, determine that a downstream hyperloop vehicle is at a safe distance from the upstream hyperloop vehicle. If the downstream hyperloop vehicle is deemed to be too close (based on the transponder data), the upstream hyperloop vehicle may turn to reliance on line-of-sight sensor data.

The hyperloop vehicle 110 may have a wireless communication system 223 that is generally configured for wireless communication. In one aspect, the wireless communication system 223 is comprised of a wireless modem (e.g., a 5G modem) that is in communication with a cellular tower or satellite (e.g., the high-speed communication network 111). One of skill in the art will appreciate that many regulations affect the design and operation of transportation modalities, including hyperloop. For certain operations, the transponder 109A is required by regulation. However, some communication may be sent over wireless communication channels via the wireless communication system 223.

In one aspect, WIFI connectivity may be provided to passengers within the hyperloop vehicle 110 via the wireless communication system 223 (as provided by the high-speed communication network 111). In another aspect, the wireless communication system 223 may be utilized to transmit emergency and diagnostic data with systems which are external to the hyperloop vehicle 110. For example, if the hyperloop vehicle 110 is halted in the plurality of tube sections 105N and unable to move, a diagnostic system may gather information related to the failure of the hyperloop vehicle 110 such that anyone from first responders to technicians may utilize the information to address the failure, rescue passengers, move the hyperloop vehicle, etc.

The hyperloop vehicle 110 comprises a line-of-sight system 219. The line-of-sight system 219 is configured to detect an object downstream from the hyperloop vehicle 110. In situations where the transponder communication system 221 is unable to ascertain the state of a downstream hyperloop vehicle, the line-of-sight system 219 is configured to detect downstream hyperloop vehicles. The line-of-sight system 219 enables safe low-velocity movement. When the hyperloop vehicle 110 passes the transponder 109A, the hyperloop vehicle 110 communicates position and velocity to the transponder 109A. When a second hyperloop vehicle passes by the transponder 109A, the position and velocity information (from the first hyperloop vehicle 110) may be relayed to said second hyperloop vehicle. One of skill in the art will appreciate that an object, a hazard, a vehicle, etc. are used as similar terms to simply indicate that an object is within the track assembly 100.

However, transponder-based messaging may not be relied upon at all times. Any number of factors may affect the reliability of transponder-based communication. In one situation, transponder-based messaging may not provide required information if two hyperloop vehicles are both positioned within the same interval of transponders. For example, if two hyperloop vehicles are positioned between the transponders 109A, 109B. One of skill in the art will appreciate that the distance between transponders 109A, 109B may be much greater (or smaller) than the distances depicted in FIG. 1 above such that this situation arises more or less frequently. At hyperloop portals, the line-of-sight system 219 is configured to provide detection of nearby hyperloop vehicles in order to maintain the proper collision margin (e.g., the collision margin 507). In another aspect, the line-of-sight system 219 provides support for convoying operations.

The hyperloop vehicle 110 comprises a primary traction system 213. The primary traction system 213 is generally configured to provide guidance, levitation, and/or propulsion to the hyperloop vehicle 110. In one aspect, the primary traction system 213 is configured to provide forward and reverse propulsion to the hyperloop vehicle 110, i.e., driving force and braking force (depending on perspective). When operating in a reverse direction, the primary traction system 213 may perform regenerative braking which converts kinetic energy into electrical energy, that may be stored in a battery for later use.

The hyperloop vehicle 110 comprises a secondary braking system 215. The secondary braking system 215 is generally configured to generate an eddy current in order to provide braking force. In one aspect, the secondary braking system 215 may create magnetic flux interactions with elements of the plurality of tube sections 105N via an electromagnetic coil. When the electromagnetic field encounters varying flux densities in the plurality tube sections 105N, an eddy current may be generated that increases braking force between the hyperloop vehicle 110 and the plurality of tube sections 105N. Generating an eddy current for braking provides a high jerk rate with a strong braking force at high velocity—which may be necessary in an emergency situation.

The hyperloop vehicle 110 comprises a plurality of power electronic units 225Z comprising a first power electronic unit 225A, a second power electronic unit 225B, a third power electronic unit 225C, a fourth power electronic unit 225D, a fifth power electronic unit 225E, a sixth power electronic unit 225F, a seventh power electronic unit 225G, and an eighth power electronic unit 225H. Each of the power electronic units 225A, 225B, 225C, 225D, 225E, 225F, 225G shown in the instant figure are substantially similar in kind and operation for illustrative purposes. Further, another eight power electronic units are disposed on the opposite, lateral side of the hyperloop vehicle viz. the left side.

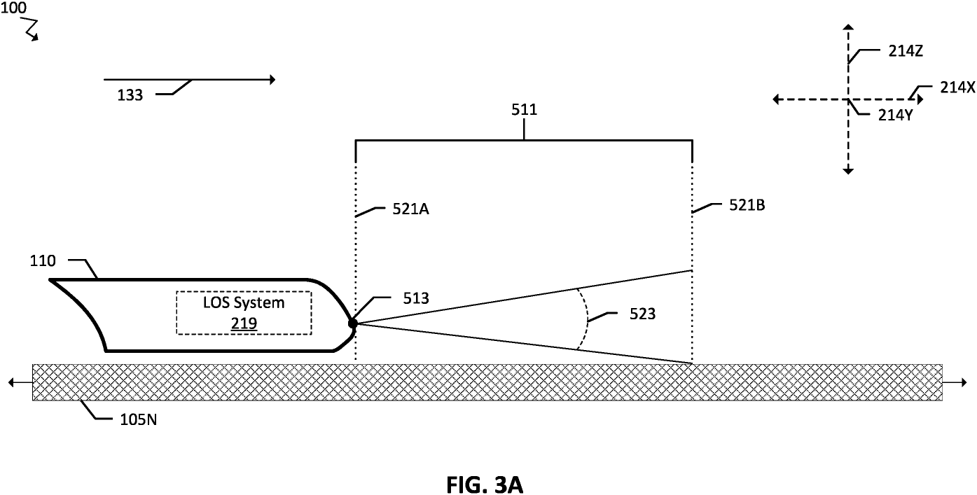

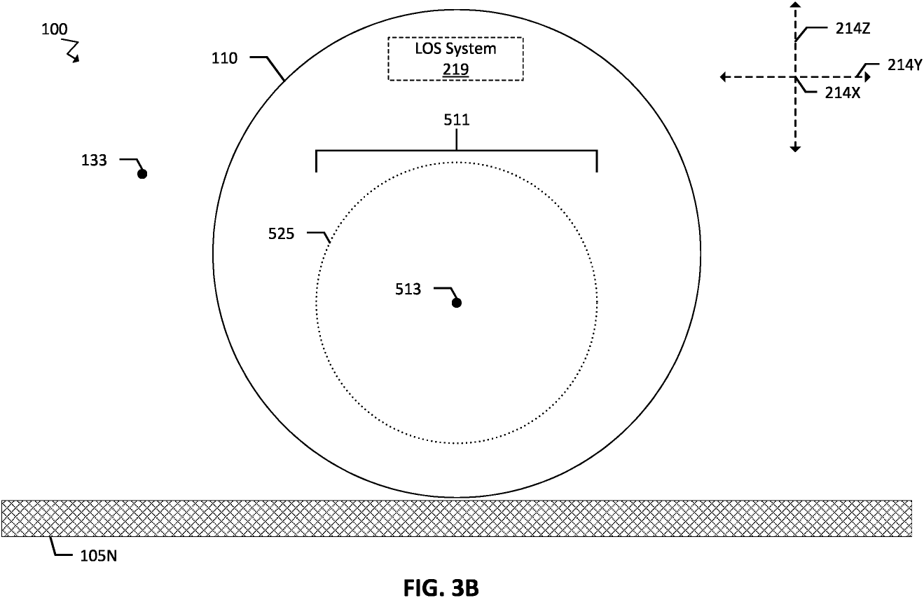

FIG. 3A is a block diagram of the hyperloop vehicle 110 positioned on the track assembly 100, as shown from a side perspective. The hyperloop vehicle 110 comprises a line-of-sight sensor location 513 at which a plurality of sensors is placed. Different sensors perform different functions within the line-of-sight 219. For example, the following are some examples of sensors within the line-of-sight system 219: LiDAR, radar, camera, laser-based sensor, ultrasonic, infrared, computer vision, etc.

One of skill in the art will appreciate that the position of the line-of-sight location 513 is illustrative because the line-of-sight system 219 may have sensors located at any position in the hyperloop vehicle 110. Some factors regarding placement of sensors are difficult to plan without a clear understanding of the tube structure in which the hyperloop vehicle 110 is operating. Therefore, a laser-based sensor (e.g., a rangefinder) may be disposed on the dorsal side of the hyperloop vehicle 110 to reduce interference with a LiDAR sensor that is positioned at the nose of the hyperloop vehicle 110.

As shown, the line-of-sight distance 511 is bounded by a first axis 521A and a second axis 521B. A conical projection extends from the line-of-sight sensor location 513 at an angle 523. The value of the angle 523 may depend on the sensor deployed in the hyperloop vehicle 110. The field of view defined by the angle 523 may depend on the curvature of the tube. At a minimum curvature radius (e.g., twenty-five meters) and a speed of fifty meters per second, the field of view for convoying operations may be approximately fifty degrees.

FIG. 3B is a block diagram of the hyperloop vehicle 110 positioned on the track assembly 100, as shown from a front perspective. A boundary 525 corresponds to the line-of-sight distance 511. The line-of-sight system 219 is configured such that the area of coverage is positioned at various points of the hyperloop vehicle 110 (including forward, rearward, and/or laterally). The boundary 525 may be the result of defining a one-hundred-and-eighty-degree angle laterally to the plurality of tube sections 105N, i.e., the axis 214Y. The boundary 525 may be defined such that a hyperloop vehicle (e.g., a second hyperloop vehicle, not shown) operating near the lateral sides of the hyperloop vehicle 110 may be detected. Such detection may be critical to junctions of two sections of rail. For example, two hyperloop vehicles may be traveling toward one another at or near the tube section 105D, as shown in FIG. 1.

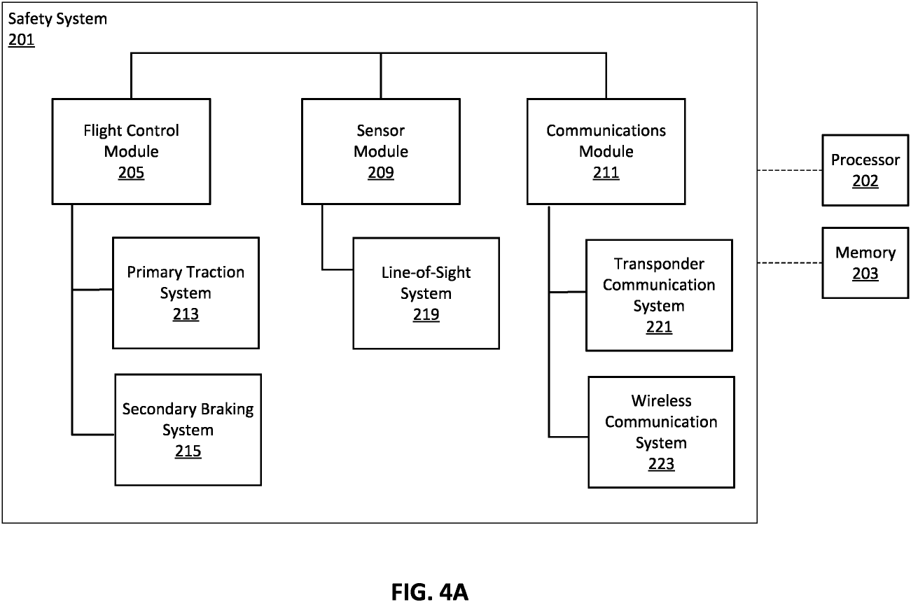

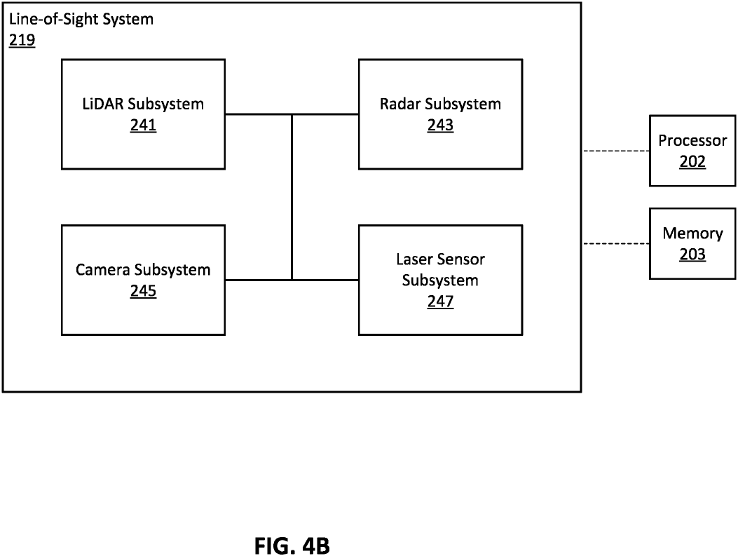

FIG. 4A is a block diagram illustrating a safety system 201. The safety system 201 is generally configured to manage the systems, subsystems, components, modules, etc. of the hyperloop vehicle 110. While a commercialized hyperloop vehicle may have hundreds of systems, the instant figure is elegant in order to highlight aspects of the safety system 201.

The safety system 201 is connected to a processor 202 and a memory 203. The processor 202 may be a shared processor which is utilized by other systems, modules, etc. within the hyperloop vehicle 110. For example, the processor 202 may be configured as a general-purpose processor (e.g., x86, ARM, etc.) that is configured to manage operations from many disparate systems, including the safety system 201. In another aspect, the processor 202 may be an abstraction because any of the modules, systems, or components disclosed herein may have a local processor or controller that handles aspects of the safety system 201 (e.g., ASICs, FPGAs, etc.).

The memory 203 is generally configured to store and retrieve information. The memory 203 may be comprised of volatile memory, non-volatile memory, or a combination thereof. The memory 203 may be closely coupled to the processor 202, in one aspect. For example, the memory 203 may be a cache that is co-located with the processor 202. As with the processor 202, the memory 203 may, in one aspect, be an abstraction wherein the modules, systems, and components each have a memory that acts in concert across the safety system 201.

The safety system 201 comprises a flight control module 205, a sensor module 209, and a communications module 211. The flight control module 205 is generally configured to manage the primary traction system 213 and the secondary braking system 215. Further, the flight control module 305 is configured to manage other systems that are essential to the operation of the hyperloop vehicle 110 while in flight. For example, the flight control module 205 may manage guidance, levitation, propulsion, and/or track switching.

The sensor module 209 is generally configured to obtain sensor data. The obtained sensor data may be utilized by the flight control module 205 and the communications module 211. For example, the sensor module 209 may detect the current velocity of the hyperloop vehicle 110 and relay said current velocity to the flight control module 205. In another aspect, the communications module 211 may relay velocity information obtained by the sensor module 209 to a nearby transponder (e.g., the transponder 109A).

One of skill in the art will appreciate that the flight control module 205 is configured for redundancy and safety; as such, sensor data may be sent to any destination relevant for the safe operation of the hyperloop vehicle. For example, the flight data may be sent to a fleet operations center that is charged with managing many traffic elements in the track assembly 100 viz. hyperloop vehicles, cranes, cargo tractors, trucks, rail vehicles, etc. One of skill in the art will appreciate that hyperloop is often deployed adjacent to many existing modes of transportation and therefore may require comprehensive management of several modes in order to facilitate the safe operation of the hyperloop vehicle 110.

The sensor module 209 comprises a line-of-sight system 219 that is generally configured to detect objects downstream from the hyperloop vehicle 110. In one aspect, the line-of-sight system 219 may detect objects approximately two hundred meters ahead of the hyperloop vehicle 110. The line-of-sight system 219 is configured for detection of objects when the hyperloop vehicle 110 and the object are both between the same transponder interval. With a placement of transponders at ~30 meters, the line-of-sight system 219 provides enough distance to ensure a proper braking distance, provided the braking distance is less than ~30 meters. One of skill in the art will appreciate that the line-of-sight system 219 operates with or without the plurality of transponders 109N, irrespective of the placement of said transponders. Thus, the line-of-sight system 219, as configured, is particularly advantageous in itself but also when complemented by the plurality of transponders 109N (when set at any reasonable interval).

The line-of-sight system 219 may also be configured to detect objects beyond a transponder interval as well. In general, transponder communication is more frequently used for collision avoidance. However, the line-of-sight system 219 provides a reliable, safe backup in the event the transponder-based communication is unreliable. Given the high speed of hyperloop, many systems provide several layers of protection to the hyperloop vehicle 110. Those skilled in the art may provide for line-of-sight systems that far exceed the distance interval between two transponders, as an added layer of safety.

The line-of-sight system 219 may be configured as a standalone system or be integrated into other safety systems (e.g., transponder communication, GPS, mechanical safety mechanisms, fire suppression systems, etc.). Further, the line-of-sight system 219 may be distributed throughout the hyperloop vehicle 110 via other safety systems in order to increase the scope and/or resolution of the line-of-sight itself. For example, the lateral sides of the hyperloop vehicle 110 may have shortened line-of-sight systems that assist with track navigation (e.g., through non-moving switches). An example device for such lateral placement would be a laser sensor configured to triangulate and determine distances and/or placements of objects adjacent to the hyperloop vehicle 110.

The communications module 211 is generally configured to manage communication between the hyperloop vehicle 110 and the objects outside of the hyperloop vehicle 110. The communications module 211 comprises a transponder communication system 221. The transponder communication system 221 is generally configured to communicate with a transponder (e.g., the transponder 109A). Such transponder communication may be critical to calculating the collision margin 507. For example, as a downstream hyperloop vehicle passes a transponder, the following hyperloop vehicle may obtain the velocity and the position of the downstream hyperloop vehicle when the upstream hyperloop vehicle passes the same transponder.

The communications module 211 is configured to manage the wireless communication system 223. In one aspect, the wireless communication system 223 may be configured to communicate with a cellular communication network which covers the track assembly 100. In another aspect, the wireless communication system 223 may be configured to communicate with a satellite system (e.g., to obtain GPS coordinates). Such forms of wireless communication may be part of the high-speed communication network 111.

FIG. 4B is a block diagram of the line-of-sight system 219. The line-of-sight system 219 comprises a LiDAR subsystem 241, a radar subsystem 243, a camera subsystem 245, and a laser subsystem 247. The processor 202 and the memory 203 may be configured to execute and store the line-of-sight system 219 such that processes in the various subsystems 241, 243, 245, 247 may perform intended functions (e.g., detecting objects, communicating sensor data, etc.).

For the purposes of this disclosure, two modes of operation are of interest. The first is “normal mode” where the hyperloop vehicle 110 is operating such that the full range of operations of the hyperloop vehicle 110 are available. For instance, the hyperloop vehicle 110 is capable, based on the state of the track assembly 100, to travel at full speeds. Further, the normal mode is typically associated with having a sufficient number of transponder interval distances between two hyperloop vehicles (or objects) such safe travel is ensured.

The second mode is “caution mode,” where speeds are reduced to ensure collisions are avoided. Typically, the caution mode is engaged when the collision margin 507 is such that the hyperloop vehicle 110 has high confidence that no downstream hyperloop vehicles are blocking the path of travel. The caution mode may be applicable to certain situations that demand lower velocities. For example, when the hyperloop vehicle 110 is entering a portal, the velocities may need to be reduced such that the hyperloop vehicle 110 may pickup or deliver passengers and/or cargo. Further, the caution mode is useful for maintenance and stabling operations.

“Convoying” is a common operation for hyperloop because the hyperloop vehicles typically coordinate to move cargo and/or passengers. For example, several hyperloop vehicles may be arranged one after the other along the plurality of tube sections 105N, thus “convoying” or placing the hyperloop vehicles into a convoy. Convoying may occur during the normal mode and/or the safety mode. Even though two hyperloop vehicles may be dozens of kilometers apart, the two could be still convoying because the two hyperloop vehicle are being coordinated in operation. Similarly, two hyperloop vehicles operating using caution mode may still be convoying. For example, the two hyperloop vehicles may be following one another at a portal while moving slowly toward a docking bay. The line-of-sight system 219 is particularly useful for low-speed convoying operations because transponders are too far apart (i.e., the transponder interval distance 515 is large).

The LiDAR subsystem 241 is generally configured to detect objects using one or more laser sensors configured to determine the distance (and/or position) of an object. Several LiDAR sensors may be configured to form an array in order to generate a three-dimensional image of the object to be observed. The LiDAR subsystem 241 is particularly useful in convoying applications (e.g., several hyperloop vehicles following one another, typically in close proximity to one another). Further, the LiDAR subsystem 241 may be utilized to detect objects during a caution mode (or “limp mode”), wherein the hyperloop vehicle 110 is operating at a lower velocity to ensure safety. Caution mode is likewise used in hyperloop portals to enable the safe docking and transfer of cargo, passengers, or a combination thereof.

For the purposes of hyperloop travel, the LiDAR subsystem 241 may need certain parameters configured to enable the proper gathering of data. For instance, the latency of the LiDAR subsystem 241 may be configured to be approximately 0.1 seconds between observation and relaying the observed data to the requesting system (e.g., the line-of-sight system 219). The vertical field of view for the LiDAR subsystem 241 may be at least twenty degrees in the vertical axis (e.g., along the axis 214Z). The angular resolution of the LiDAR subsystem 241 may be less than 0.4 degrees; however, one of skill in the art will appreciate that lower angular resolution may relate to high amounts of data which is generally beneficial to object detection (though more resource intensive).

The range of the LiDAR subsystem 241 may be at least two hundred meters, but higher range values are desirable, if technically and economically feasible. One of skill in the art will appreciate that the line-of-sight limitation is also defined by the curvature of the tube itself. The operating temperature of the LiDAR subsystem 241 is approximately -40 degrees to 55° C. The sampling rate of the LiDAR subsystem 241 may be at least 20 Hz. The Root Mean Square Amplitude (“RMS”) of vibration experienced by the LiDAR subsystem 241 may be in the range of 0.6G to 3.1G in order to adhere to the vibrations of the hyperloop vehicle 110. The estimated shock experienced by the LiDAR subsystem 241 may be 5.1G for at least a 30 ms duration. In sum, the configuration of the LiDAR subsystem 241 requires several parameters to be set in order to meet the operating requirements of hyperloop transportation.

The radar subsystem 243 is generally configured to detect objects through smoke and vapor, which is particularly useful in situations where a downstream hyperloop vehicle is emitting exhaust (e.g., due to a fire). While the radar subsystem 243 is primarily intended for object detection in the context of collision avoidance, the radar subsystem 243 may be configured to generate velocity measurements due to the high-resolution and ongoing detection of objects (especially with a high update rate).

The LiDAR subsystem 241 is generally configured to use radio waves to detect objects. The LiDAR subsystem 241 may be particularly useful in convoying applications (e.g., several hyperloop vehicles following one another, generally in close proximity to one another). Further, the LiDAR subsystem 241 may be utilized to detect objects during a caution mode, wherein the hyperloop vehicle 110 is operating at a lower velocity to ensure safety.

The camera subsystem 245 is generally configured to detect visible light as well as infrared light. Computer vision processes may process the detected light in order to generate a representation (in data) of the observations for use by the safety system 201 (and related systems and subsystems). The camera subsystem 245 may be particularly useful in convoying applications (e.g., several hyperloop vehicles following one another). Further, the camera subsystem 245 may be utilized to detect objects during a caution mode (often called “limp mode”), wherein the hyperloop vehicle 110 is operating at a lower velocity to ensure safety.

The laser sensor subsystem 247 is generally configured to act as a range sensor (e.g., a rangefinder). The laser sensor subsystem 247 may be used in convoying situations that often occur within hyperloop portals. For instance, a first hyperloop vehicle may be downstream; a second, upstream hyperloop vehicle may utilize the laser sensor subsystem 247 to obtain a distance (range) between the two hyperloop vehicles. The laser sensor subsystem 247 is generally considered a high bandwidth and a high resolution means of data gathering.

The latency of the laser sensor subsystem 247 may be less than 30 ms with a sampling rate of greater than 1 kHz. One of skill in the art will appreciate that a higher sampling rate is desirable for certain applications; however, high sampling rates incur more processing and/or resource costs, so finding a balance is critical for hyperloop applications. The horizontal field of view may be greater than five degrees. The vertical field of view of the laser sensor subsystem 247 may be greater than five degrees. In one aspect, the laser sensor subsystem 247 may obtain a data point along each of the directions of each of the axis 214X, 214Y, 214Z.

Given the large number of observations and generated data, the line-of-sight system 219 may be configured to detect defects in the track assembly 100 as well. For example, the hyperloop vehicle 110 may pass the tube section 105B and note a condition in the rail that may require maintenance. To be clear, such observations may be independent of collision detection and may simply be yet another beneficial application of the disclosed solution. Thus, the line-of-sight system 219 has prognostic capabilities that are generally advantageous to the development of safe hyperloop travel.

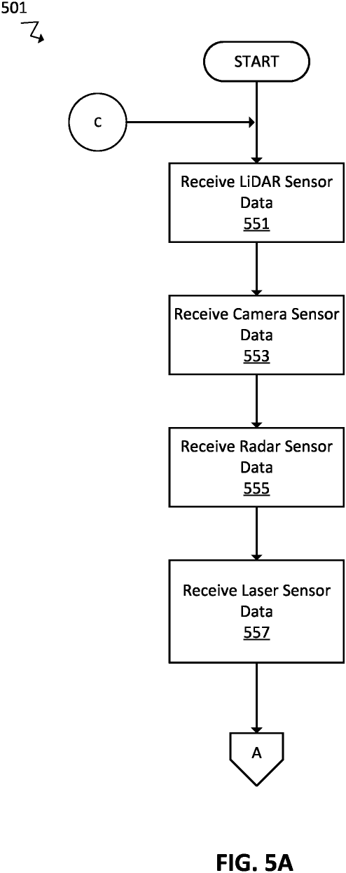

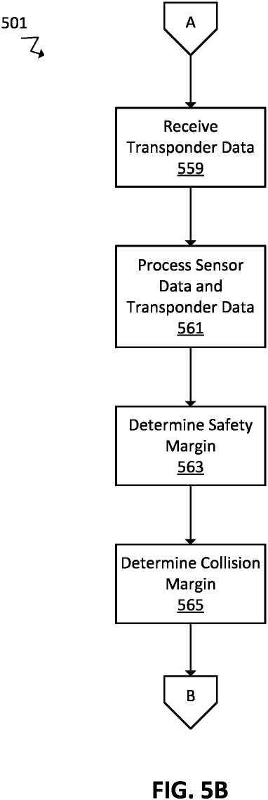

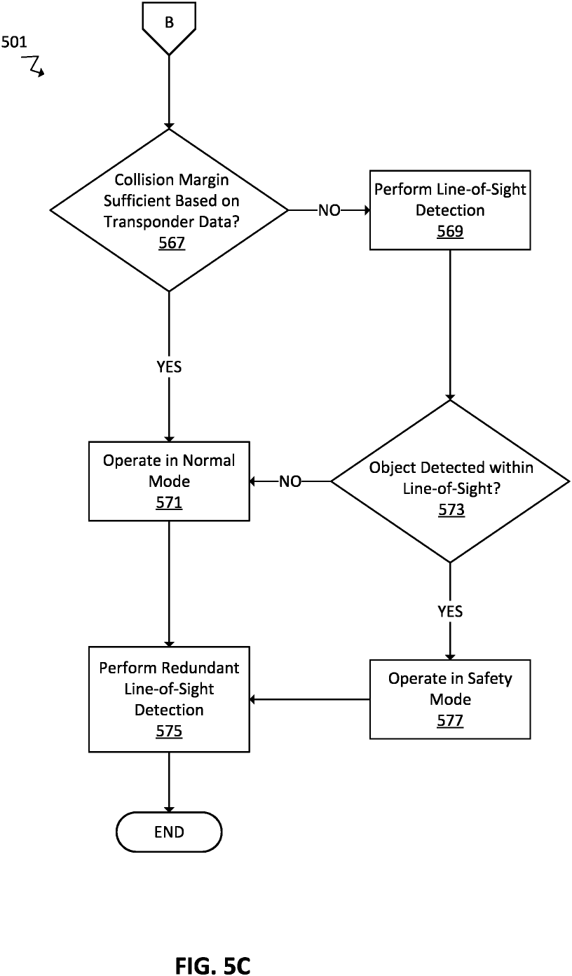

FIG. 5A is a flowchart depicting a process 501 for operating the hyperloop vehicle 110. The process 501 is generally configured to detect downstream hyperloop vehicles (and objects, hazards, etc.) and respond accordingly. For example, upon detecting a downstream hyperloop vehicle at a less-than-desired collision margin, the process 501 may take actions to address the reduced margin. The process 501 begins at the start block and proceeds to the block 551. It is worth noting that the blocks 551, 553, 555, 557 generally relate to obtaining various types of sensor data, the details of which will be disclosed below with respect to each type of sensor data obtained by the process 501.

At the block 551, the process 501 receives LiDAR sensor data. The LiDAR sensor data is obtained from the LiDAR subsystem 241, as described with respect to FIG. 4B above. The process 501 then proceeds to the block 553. At the block 553, the process 501 receives camera sensor data. The camera sensor data is obtained from the camera subsystem 245, as described with respect to FIG. 4B above. The process 501 then proceeds to the block 555. At the block 555, the process 501 receives radar sensor data. The radar sensor data may be obtained from the radar subsystem 243, as described with respect to FIG. 4B above. The process 501 then proceeds to the block 557.

At the block 557, the process receives laser sensor data. The laser sensor data is obtained from the laser sensor subsystem 247. One of skill in the art will appreciate that the sensor data obtained at the blocks 551, 553, 555, 557 may be obtained in different orders. For example, the radar sensor data may be obtained prior to the LiDAR sensor data. In general, obtaining sensor data from more sensors enables a richer fusion of the various sensor data (during later operations of the process 501). Further, the order is substantially less important than the quality and quality of the sensor data given that the sensor data and the transponder data are fused to form a comprehensive view of the environment external to the hyperloop vehicle 110. The process 501 then proceeds to the off-page reference A and continues at FIG. 5B.

FIG. 5B is a flowchart depicting the process 501 for operating the hyperloop vehicle 110. The process 501 resumes at the off-page reference A and proceeds to the block 559. At the block 559, the process 501 receives transponder data. The transponder data is distinct from the sensor data, but the two complement one another because the transponder data provides long-range data, and the line-of-sight-based data is relatively short-range data. The process 501 then proceeds to the block 561.

At the block 561, the process 501 processes the sensor data and/or the transponder data. In general, the transponder data and the sensor data complement one another. For example, the transponder data may indicate that no downstream hyperloop vehicles impede the normal mode operation of the hyperloop vehicle 110. Likewise, the sensor data may provide a similar perspective. In other words, the normal mode may imply that the transponder data and the sensor data indicate that the full range of operation of the hyperloop vehicle 110 is possible.

However, when the downstream hyperloop vehicles are too close, the transponder data is the first indication when the hyperloop vehicle 110 is in the normal mode. For example, the downstream hyperloop vehicle may be within the same transponder interval distance (e.g., the transponder interval distance 515). Therefore, the hyperloop vehicle 110 will need to rely on the sensor data to ensure the downstream hyperloop vehicle is still beyond the collision margin 507. Hence, the fusing of the transponder data and the sensor data provides for increased safety due to the comprehensive understanding of the long-range and short-range data obtained from the sensor module 209 and the communications module 211. The process 501 then proceeds to the block 563.

At the block 563, the process 501 determines the safety margin 509. The safety margin 509 may be based on a number of factors. In general, the safety margin 563 is associated with the braking distance of the hyperloop vehicle 110. For instance, the braking distance may be 1,000 meters and thus the safety margin 509 may be the braking distance plus a buffer (e.g., 10% of braking distance). Likewise, the safety margin 509 may be the collision margin 507, minus a certain value or percentage. The process 501 then proceeds to the block 565.

At the block 565, the process 501 determines the collision margin 507. The collision margin 507 is generally greater than the safety margin 509 given that the safety margin 509 is essentially the amount of distance the hyperloop vehicle 110 requires to ensure safety in extreme (often dangerous) operating conditions. The caution mode may be triggered if the collision margin 507 is inadequate for safe operation of the hyperloop vehicle 110. The process 501 then proceeds to the off-page reference B and resumes at FIG. 5C.

FIG. 5C is a flowchart depicting the process 501 for operating the hyperloop vehicle 110. The process 501 resumes at the callout block B and proceeds to the decision block 567. At the decision block 567, the process 501 determines whether the collision margin 507 is sufficient based on the transponder data. The determination is largely informed by whether the downstream hyperloop vehicle is at a transponder interval distance (e.g., the transponder interval 515) that is sufficient to enable safe braking of the hyperloop vehicle 110. In other words, whether the safety margin 509 may be maintained and acted upon, based on the downstream activity of hyperloop vehicles (and objects). If the process 501 determines the collision margin 507 is sufficient, the process 501 proceeds along the YES branch to the block 571, at which the process 501 operates the hyperloop vehicle 110 in the normal mode.

Returning to the decision block 567, if the collision margin 507 is insufficient based on the transponder data, the process 501 proceeds along the NO branch to the block 569. At the block 569, the process 501 performs line-of-sight detection. Line-of-sight detection generally relies on the sensor module 209 as well as the line-of-sight system 219, both of which are described in detail at FIG. 4A above. The process 501 then proceeds to the decision block 573.

At the decision block 573, the process 501 determines whether an object, vehicle, and/or hazard has been detected within the line-of-sight distance 511. If an object, vehicle, and/or hazard has been detected, the process 501 proceeds along the YES branch to the block 577 at which the process 501 will operate the hyperloop vehicle 110 in the caution mode.

Returning to the decision block 573, if the process 501 determines that no object, vehicle, and/or hazard has been detected within the collision margin 507, the process 501 proceeds along the NO branch to the block 571. As stated at the block 571, the hyperloop vehicle 110 operates in the normal mode. To be clear, the normal mode is generally associated with a situation where no downstream objects and/or vehicles are present to impede the full range of operation of the hyperloop vehicle 110.

Returning to the block 577, the process 501 proceeds to the block 575. Note, the block 571 also flows to the block 575. At the block 573, the process 501 performs redundant line-of-sight detection. While the hyperloop vehicle 110 may rely on transponder data for a majority of the journey, the process 501 still operates the line-of-sight system 219 in order to ensure that objects are not present. Such detection is performed to enhance safety because transponder data may, like any data, be inaccurate or misleading. Thus, having the line-of-sight system 219 utilized by the process 501 enables safer operation of the hyperloop vehicle 110 than that without the line-of-sight system 219 (and the broader operation of the sensor module 209). The process 501 then proceeds to the end block and terminates.

Reference C is denoted on FIG. 5A in order to show that the process 501 may iterate, ad infinitum, during the typical journey of the hyperloop vehicle 110. For example, the hyperloop vehicle 110 may alternate between the normal mode and the caution mode depending on the state of the transponder data, the sensor data, and any associated activity with respect to the transponders 109N. Likewise, the hyperloop vehicle 110 may encounter downstream hyperloop vehicles in the normal course of operation. For example, the hyperloop vehicle 110 may not be able to rely upon transponder data in a portal. As such, the process 501 will focus on the line-of-sight detection instead of relying more heavily on transponder data.

One of skill in the art will appreciate that sensor data is constantly being updated based on new information. In sum, the process 501 is highly dynamic when implemented but still addresses the core goals of the disclosed solution which include increasing reliability, safety, and efficiency of hyperloop travel.

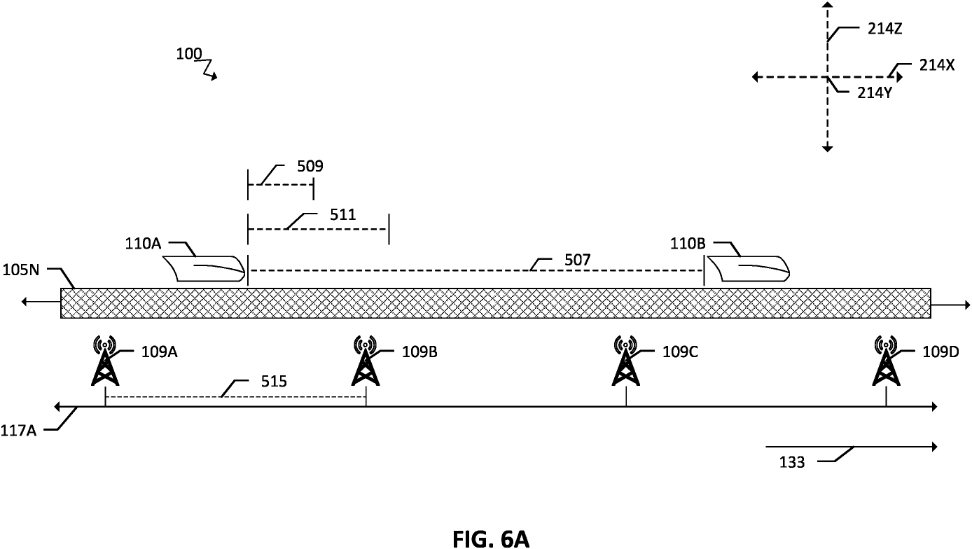

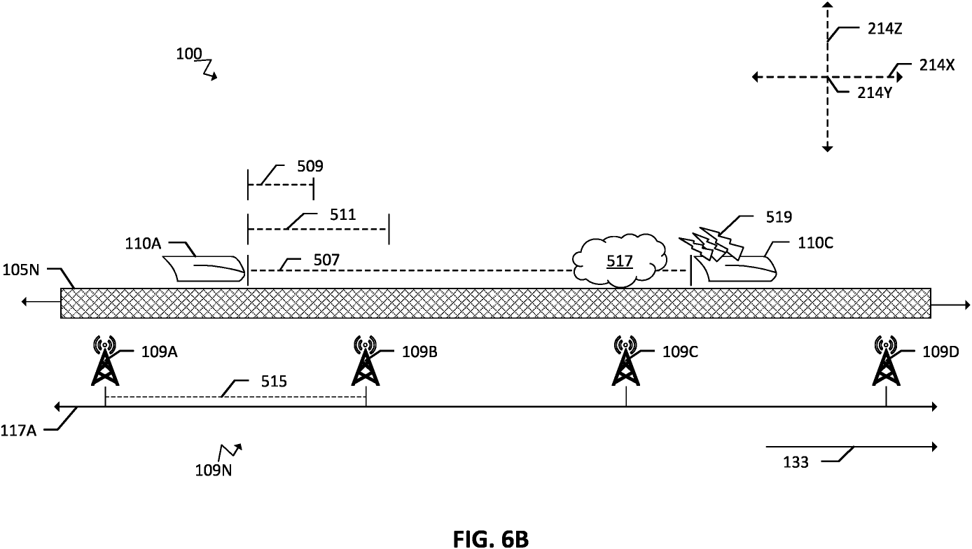

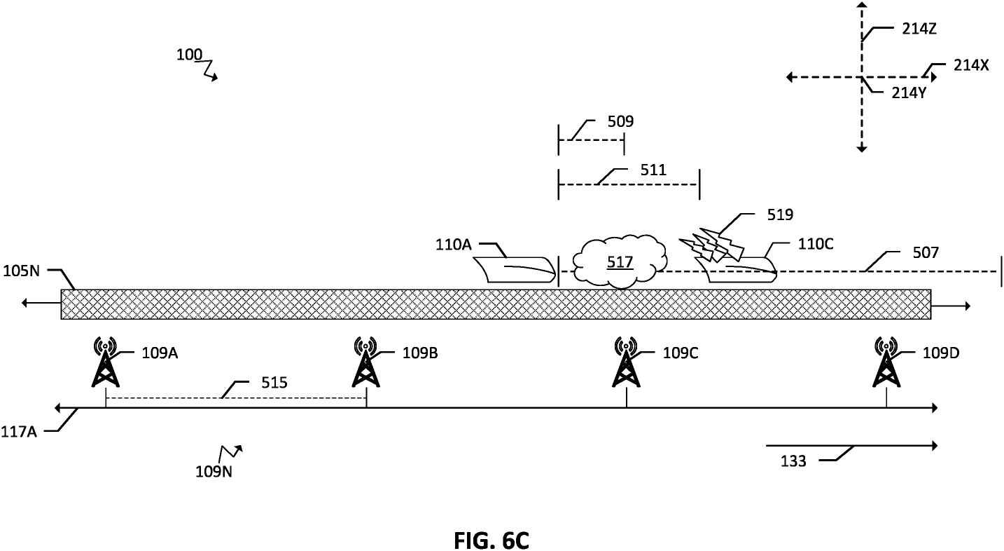

FIG. 6A is a block diagram illustrating the track assembly 100, shown from a side perspective. A transponder interval distance 515 separates the transponder 109A from the transponder 109B. A distance may exist between each of the transponders 109A, 109B, 109C, 109D that is substantially similar to the transponder interval distance 515. A first hyperloop vehicle 110A and a second hyperloop vehicle 110B are shown in the instant figure to demonstrate the interactions in a real-world application of the line-of-sight system 219. The hyperloop vehicles 110A, 110B are substantially similar to the hyperloop vehicle 110 as described herein.

As shown in the instant figure, the first hyperloop vehicle 110A is maintaining the collision margin 507 greater than the safety margin 509. Therefore, the hyperloop vehicle 110A is operating safely and able to move at high speeds as necessary. The first hyperloop vehicle 110A is operating between the transponder 109A and the transponder 109B. The second hyperloop vehicle 110B is operating between the transponder 109C and the transponder 109D. The second hyperloop vehicle 110B has passed the transponder 109A as well as the transponder 109B. When the hyperloop vehicle 110A passes the transponders 109A, 109B, 109C, the hyperloop vehicle 110A may gather velocity information relating to the hyperloop vehicle 110B.

For example, the hyperloop vehicle 110B may pass the transponder 109C and relay velocity information to the transponder 109B via the link 117A. As the hyperloop vehicle 110A passes the transponder 109B, the velocity information may be transmitted from the transponder 109B to the hyperloop vehicle 110A. One of skill in the art will appreciate how a downstream hyperloop vehicle may communicate information to an upstream hyperloop vehicle via the plurality of transponders 109N (e.g., as disclosed with respect to the block 559). Further, one of skill in the art will appreciate that other information may be likewise communicated via the plurality of transponders 109N, including, but not limited to, position, acceleration, orientation, weight, energy storage, safety information, passenger information, maintenance information, fare information, etc.

The line-of-sight detection distance 511 is depicted similarly to the distance 511 shown above in FIG. 1. The line-of-sight detection distance 511 is substantially shorter than the collision margin 507, as shown in the instant figure. In the depicted situation, the collision margin 507 is so substantial, that the plurality of transponders 109N may be relied upon for collision detection and avoidance. In other words, the hyperloop vehicles 110A, 110B are operating at transponder-interval-based distances that are sufficient to reduce reliance on line-of-sight detection. Thus, the hyperloop vehicle 110A is able to operate in the normal mode as describe in the block 571.

One of skill in the art will appreciate that the line-of-sight distance 511 is still relevant even though the collision margin 507 is much greater. In the event that the plurality of transponders 109N or the transponder communication system 221 fail, the line-of-sight system 219 may provide a fallback mechanism for safety as described with respect to the block 575. For instance, the autonomous pod protection module 201 may invoke autonomous braking operations using the secondary braking system 215. In another example, the safety system 201 may cause the hyperloop vehicles 110A, 110B to enter a caution mode. The caution mode may result in lower velocities such that the line-of-sight distance 511 is not exceeded for a braking distance (or margin).

FIG. 6B is a block diagram illustrating the track assembly 100, shown from a side perspective. As depicted, the line-of-sight detection distance 511 is such that the presence of a hyperloop vehicle 110C may be detected using the line-of-sight system 219. As with the hyperloop vehicles 110A, 110B, the hyperloop vehicle 110C is substantially similar to the hyperloop vehicle 110. The collision margin 507 is shown as being greater than the safety margin 509.

A hazard 517 is present and has significantly blocked a visual line-of-sight to the hyperloop vehicle 110C. The hyperloop vehicle 110C is in distress as shown by a fire hazard 519. Given that the collision margin 507 is still greater than both the safety margin 509 and the line-of-sight distance 511, the hyperloop vehicle 110A is operating in the normal mode. Stated differently, the line-of-sight distance 511 is not currently detecting any hazards. However, as the hyperloop vehicle 110A proceeds along the direction of travel 133, the collision margin 507 will continue to decrease, thus creating a more dangerous scenario.

FIG. 6C is a block diagram illustrating the track assembly 100, shown from a side perspective. The hyperloop vehicle 110A has approached the disabled hyperloop vehicle 110C - to such an extreme degree that the collision margin 507 has passed the tail of the hyperloop vehicle 110C. However, the line-of-sight distance 511 is able to begin detecting the disabled hyperloop vehicle 110C. As shown, the hazard 517 is smoke and potentially blocking visible light.

The radar subsystem 243 may be utilized to gather observations within the hazard 517 as well as beyond the hazard 517 (e.g., as described at the block 551). As discussed in FIG. 4B above, the LiDAR subsystem 241 may generate a three-dimensional map of any objects detected within the line-of-sight distance 511. As shown in the instant figure, the tail of the hyperloop vehicle 110C may be detected because the line-of-sight distance 511 exceeds the position of the distressed hyperloop vehicle 110C.

The camera subsystem 245 is configured to detect any visible indications related to the hazard 517 (e.g., as described at the block 553). For example, if black, thick smoke is detected, the computer vision functionality in the line-of-sight system 219 may determine, with high probability, that the black smoke is being generated from a fire. As disclosed above in FIG. 4B, the camera subsystem 245 may detect infrared light and thus be configured to detect heat signatures that indicate an object or hazard is downstream (and potentially burning). In instant figure, the camera subsystem 245 may detect heat from the fire hazard 519 as well as heat in the hazard 517.

The radar subsystem 243 is similarly configured to detect the smoke hazard 517 (e.g., as described at the block 555). Likewise, the laser sensor subsystem 247 may be utilized to detect the smoke hazard 517. As disclosed, the various subsystems 241, 243, 245, 247 may operate in coordination to provide safety to the hyperloop vehicle 110A. In the instant illustration, one of skill in the art will appreciate that each of the subsystems 241, 243, 245, 247 performs a different function with different advantages and limitations. For instant, the radar subsystem 243 may be more heavily relied upon because radar penetrates through gaseous hazards (e.g., vapor, smoke, etc.). In contrast, the camera subsystem 245 may be less relied upon because the visible light reflecting from the distressed hyperloop vehicle 110C may be obscured by the smoke hazard 517.

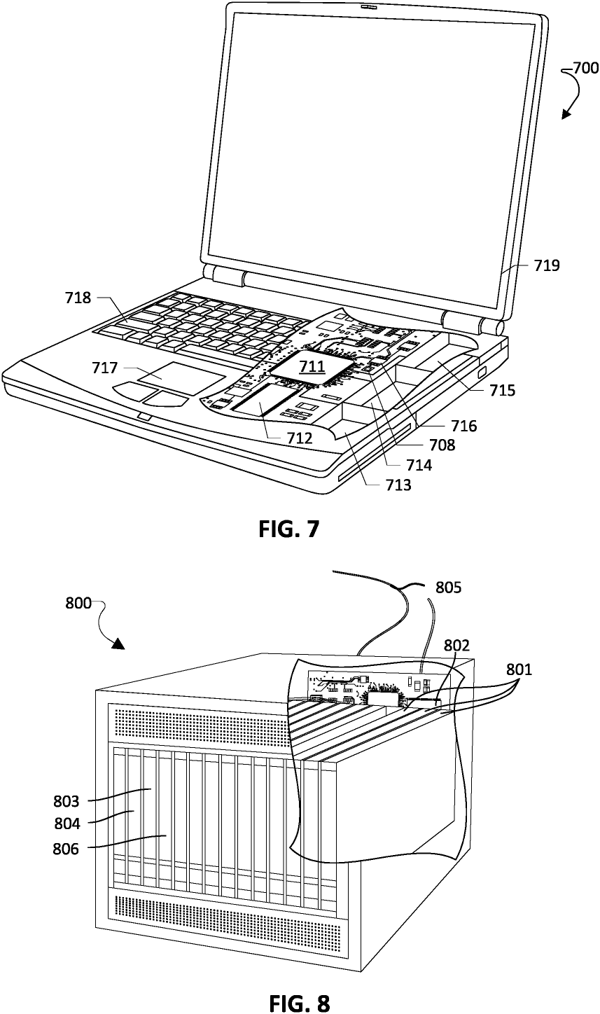

FIG. 7 is a block diagram illustrating a computing device 700 suitable for use with the various aspects described herein. The computing device 700 may store and process the processes and data associated with the track assembly 100 and the hyperloop vehicle 110. In particular, the safety system 201, including the line-of-sight system 219, may similarly be stored and processed. Further, the process 501 may be similarly stored and processed by the computing device 700.

The computing device 700 may include a processor 711 (e.g., an ARM processor) coupled to volatile memory 712 (e.g., DRAM) and a large capacity nonvolatile memory 713 (e.g., a flash device). Additionally, the computing device 700 may have one or more antenna 708 for sending and receiving electromagnetic radiation that may be connected to a wireless data link and/or cellular telephone transceiver 716 coupled to the processor 711. The computing device 700 may also include an optical drive 714 and/or a removable disk drive 715 (e.g., removable flash memory) coupled to the processor 711. The computing device 700 may include a touchpad touch surface 717 that serves as the computing device’s 700 pointing device, and thus may receive drag, scroll, flick etc. gestures similar to those implemented on computing devices equipped with a touch screen display as described above. In one aspect, the touch surface 717 may be integrated into one of the computing device’s 700 components (e.g., the display). In one aspect, the computing device 700 may include a keyboard 718 which is configured to accept user input via one or more keys within the keyboard 718. In one configuration, the computing device’s 700 housing includes the touchpad 717, the keyboard 718, and the display 719 all coupled to the processor 711. Other configurations of the computing device 700 may include a computer mouse coupled to the processor (e.g., via a USB input) as are well known, which may also be used in conjunction with the various aspects described herein.

FIG. 8 is a block diagram illustrating a server 800 suitable for use with the various aspects described herein. The server 800 may store and process the processes and data associated with the track assembly 100 and the hyperloop vehicle 110. In particular, the safety system 201, including the line-of-sight system 219, may similarly be stored and processed. Further, the process 501 may be stored and processed by the server 800.

The server 800 may include one or more processor assemblies 801 (e.g., an x86 processor) coupled to volatile memory 802 (e.g., DRAM) and a large capacity nonvolatile memory 804 (e.g., a magnetic disk drive, a flash disk drive, etc.). As illustrated in instant figure, processor assemblies 801 may be added to the server 800 by insertion into the racks of the assembly. The server 800 may also include an optical drive 806 coupled to the processor 801. The server 800 may also include a network access interface 803 (e.g., an ethernet card, WIFI card, etc.) coupled to the processor assemblies 801 for establishing network interface connections with a network 805. The network 805 may be a local area network, the Internet, the public switched telephone network, and/or a cellular data network (e.g., LTE, 5G, etc.).

The foregoing method descriptions and diagrams/figures are provided merely as illustrative examples and are not intended to require or imply that the operations of various aspects must be performed in the order presented. As will be appreciated by one of skill in the art, the order of operations in the aspects described herein may be performed in any order. Words such as “thereafter,” “then,” “next,” etc. are not intended to limit the order of the operations; such words are used to guide the reader through the description of the methods and systems described herein. Further, any reference to claim elements in the singular, for example, using the articles “a,” “an,” or “the” is not to be construed as limiting the element to the singular.

Various illustrative logical blocks, modules, components, circuits, and algorithm operations described in connection with the aspects described herein may be implemented as electronic hardware, computer software, or combinations of both. To clearly illustrate this interchangeability of hardware and software, various illustrative components, blocks, modules, circuits, operations, etc. have been described herein generally in terms of their functionality. Whether such functionality is implemented as hardware or software depends upon the particular application and design constraints imposed on the overall system. One of skill in the art may implement the described functionality in varying ways for each particular application, but such implementation decisions should not be interpreted as causing a departure from the scope of the claims.

The hardware used to implement various illustrative logics, logical blocks, modules, components, circuits, etc. described in connection with the aspects described herein may be implemented or performed with a general purpose processor, a digital signal processor (“DSP”), an application specific integrated circuit (“ASIC”), a field programmable gate array (“FPGA”) or other programmable logic device, discrete gate logic, transistor logic, discrete hardware components, or any combination thereof designed to perform the functions described herein. A general-purpose processor may be a microprocessor, a controller, a microcontroller, a state machine, etc. A processor may also be implemented as a combination of receiver smart objects, e.g., a combination of a DSP and a microprocessor, a plurality of microprocessors, one or more microprocessors in conjunction with a DSP core, or any other such like configuration. Alternatively, some operations or methods may be performed by circuitry that is specific to a given function.

In one or more aspects, the functions described may be implemented in hardware, software, firmware, or any combination thereof. If implemented in software, the functions may be stored as one or more instructions (or code) on a non-transitory computer-readable storage medium or a non-transitory processor-readable storage medium. The operations of a method or algorithm disclosed herein may be embodied in a processor-executable software module or as processor-executable instructions, both of which may reside on a non-transitory computer-readable or processor-readable storage medium. Non-transitory computer-readable or processor-readable storage media may be any storage media that may be accessed by a computer or a processor (e.g., RAM, flash, etc.). By way of example but not limitation, such non-transitory computer-readable or processor-readable storage media may include RAM, ROM, EEPROM, NAND FLASH, NOR FLASH, M-RAM, P-RAM, R-RAM, CD-ROM, DVD, magnetic disk storage, magnetic storage smart objects, or any other medium that may be used to store program code in the form of instructions or data structures and that may be accessed by a computer. Disk as used herein may refer to magnetic or non-magnetic storage configured to store instructions or code. Disc refers to any optical disc configured to store instructions or code. Combinations of any of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed aspects is provided to enable any person skilled in the art to make, implement, or use the claims. Various modifications to these aspects will be readily apparent to those skilled in the art, and the generic principles defined herein may be applied to other aspects without departing from the scope of the claims. Thus, the present disclosure is not intended to be limited to the aspects illustrated herein but is to be accorded the widest scope consistent with the claims disclosed herein.

1. A method for a first hyperloop vehicle to operate on a track assembly, the method comprising:
determining, at a processor, a safety margin of the first hyperloop vehicle, the safety margin being associated with a braking distance of the first hyperloop vehicle, the first hyperloop vehicle being upstream from a second hyperloop vehicle;
receiving, at the processor, sensor data within a line-of-sight distance;
receiving, at the processor, transponder data from a first transponder;
determining, at the processor, a collision margin;
determining, at the processor and based on the sensor data and the transponder data, whether the second hyperloop vehicle is positioned outside the collision margin; and
operating, at the processor and if the second hyperloop vehicle is positioned outside the collision margin, the first hyperloop vehicle in a normal mode, the normal mode being associated with a first velocity, the first velocity being reached via use of a primary traction system.

2. The method of claim 1, the method further comprising:
operating, at the processor and if the second hyperloop vehicle is within the collision margin, the first hyperloop vehicle in a caution mode, the caution mode causing the first hyperloop vehicle to operate at a second velocity.

3. The method of claim 2, wherein the second velocity is reached by using the primary traction system, the second velocity being lower than the first velocity.

4. The method of claim 2, the method further comprising:
detecting, at the processor, the second hyperloop vehicle within a safety margin; and
causing, at the processor, the first hyperloop vehicle to engage a secondary braking system to apply a first braking force to the first hyperloop vehicle.

5. The method of claim 1, wherein the sensor data comprises LiDAR sensor data, camera sensor data, radar sensor data, laser sensor data, or a combination thereof.

6. The method of claim 5, wherein the sensor data indicates a presence of smoke via use of the LiDAR sensor data, the camera sensor data, or a combination thereof.

7. The method of claim 5, wherein the sensor data indicates a presence of fire via use of the radar sensor data, the camera sensor data, or a combination thereof.

8. The method of claim 5, wherein the sensor data is camera sensor data, the camera sensor data being processed using computer vision to detect the second hyperloop vehicle.

9. The method of claim 8, the method further comprising:
causing, at the processor, the first hyperloop vehicle to convoy behind the second hyperloop vehicle.

10. A safety system for a first hyperloop vehicle, the safety system comprising:
a memory;
a processor, the processor being configured to:
determine a safety margin of the first hyperloop vehicle, the safety margin being associated with a braking distance of the first hyperloop vehicle;
receive sensor data within a line-of-sight distance;
receive transponder data from a first transponder;
determine a collision margin;
determine, based on the sensor data and the transponder data, whether the second hyperloop vehicle is positioned outside the collision margin; and
operate, if the second hyperloop vehicle is positioned outside the collision margin, the first hyperloop vehicle in a normal mode, the normal mode being associated with a first velocity, the first velocity being reached via use of a primary traction system.

11. The safety system of claim 10, the method further comprising:
operating, at the processor and if the second hyperloop vehicle is within the collision margin, the first hyperloop vehicle in a caution mode, the caution mode causing the first hyperloop vehicle to operate at a second velocity.

12. The safety system of claim 11, wherein the second velocity is reached by using the primary traction system, the second velocity being lower than the first velocity.

13. The safety system of claim 11, the method further comprising:
detecting, at the processor, the second hyperloop vehicle within a safety margin; and
causing, at the processor, the first hyperloop vehicle to engage a secondary braking system to apply a first braking force to the first hyperloop vehicle.

14. The safety system of claim 10, wherein the sensor data comprises LiDAR sensor data, camera sensor data, radar sensor data, laser sensor data, or a combination thereof.

15. The method of claim 14, wherein the sensor data indicates a presence of smoke via use of the LiDAR sensor data, the camera sensor data, or a combination thereof.

16. The safety system of claim 14, wherein the sensor data indicates a presence of fire via use of the radar sensor data, the camera sensor data, or a combination thereof.

17. The safety system of claim 14, wherein the sensor data is camera sensor data, the camera sensor data being processed using computer vision to detect the second hyperloop vehicle.

18. The safety system of claim 17, the method further comprising:
causing, at the processor, the first hyperloop vehicle to convoy behind the second hyperloop vehicle.

19. A computer-readable medium storing instructions that, when executed by a computer, cause the computer to:
determine, at a processor, a safety margin of a first hyperloop vehicle, the safety margin being associated with a braking distance of the first hyperloop vehicle, the first hyperloop vehicle being upstream from a second hyperloop vehicle;
receive, at the processor, sensor data within a line-of-sight distance;
receive, at the processor, transponder data from a first transponder;
determine, at the processor, a collision margin;
determine, at the processor and based on the sensor data and the transponder data, whether the second hyperloop vehicle is positioned outside the collision margin; and
operate, at the processor and if the second hyperloop vehicle is positioned outside the collision margin, the first hyperloop vehicle in a normal mode, the normal mode being associated with a first velocity, the first velocity being reached via use of a primary traction system.

20. The computer-readable medium of claim 19, the instructions further causing the computer to:
operate, at the processor and if the second hyperloop vehicle is within the collision margin, the first hyperloop vehicle in a caution mode, the caution mode causing the first hyperloop vehicle to operate at a second velocity.
